(19) United States
(12) Patent Application Publication
(10) Pub. No.: US 2008/0063305 A1
(43) Pub. Date: Mar. 13, 2008

(54) APPARATUS AND METHOD FOR DISPLAYING AN ULTRASOUND IMAGE

(75) Inventor: Byoung Hoon Lim, Seoul (KR)

Correspondence Address: OBLON, SPIVAK, MCCLELLAND MAIER & NEUSTADT, P.C., 1940 DUKE STREET, ALEXANDRIA, VA, 22314, US

(73) Assignee: Medison Co., Ltd., Hongchun-gun (KR)

(21) Appl. No.: 11/832,909

(22) Filed: Aug. 2, 2007

(30) Foreign Application Priority Data
Sep. 8, 2006 (KR) 10-2006-0086888

(51) Int. Cl. G06K 9/32

(52) U.S. Cl. 382/298

(57) ABSTRACT

There is provided an image processing system, which comprises: an image data acquisition unit for acquiring image data from a target object; a processor for forming an original image based on the image data; and an input unit for receiving region of interest (ROI) setting information for setting a plurality of ROIs on the original image, wherein the processor is further operable to magnify a plurality of images within the ROIs in a preset ratio and display the plurality of magnified images together with the original image such that the magnified images are displayed on the original image.

The present application claims priority from Korean Patent Application No. 10-2006-0086888 filed on Sep. 8, 2006, the entire subject matter of which is incorporated herein by reference.

### BACKGROUND

1. Field

The present invention generally relates to ultrasound image processing systems, and more particularly to an ultrasound image processing system and a method of providing an image magnifying function.

2. Background

An ultrasound image processing system has become an important and popular diagnostic tool since it has a wide range of applications. Specifically, due to its non-invasive and non-destructive nature, the ultrasound image processing system has been extensively used in the medical profession. Modern high-performance ultrasound image processing systems and techniques are commonly used to produce two or three-dimensional diagnostic images of internal features of an object (e.g., human organs).

The ultrasound image processing system generally uses a wide bandwidth transducer to transmit and receive ultrasound signals. The ultrasound image processing system forms images of human internal tissues by electrically exciting an acoustic transducer element or an array of acoustic transducer elements to generate ultrasound signals that travel into the body. The ultrasound signals produce ultrasound echo signals since they are reflected from body tissues, which appear as discontinuities to the propagating ultrasound signals. Various ultrasound echo signals return to the transducer element and are converted into electrical signals, which are amplified and processed to produce ultrasound data for an image of the tissues.

Generally, the ultrasound image processing system provides a magnification function for visualizing a specific portion in detail. If a region of interest (ROI) desired to be magnified is set on an ultrasound image displayed on a display unit (hereinafter referred to as “original image”) in response to a ROI setting instruction inputted through a user input unit (e.g., touch pad, track ball, key board, mouse, etc.), then the ultrasound image processing system reads out ultrasound image data corresponding to the ROI from a storage unit. The read-out ultrasound image data are then image-processed so as to display a magnified ultrasound image in a preset ratio.

However, since the conventional ultrasound image processing system provides only one magnified ultrasound image for one ROI in a preset ratio, there is a problem in that a plurality of magnified ultrasound images representing different portions of the original image cannot be displayed at the same time. Also, since the conventional ultrasound image processing system displays only the magnified ultrasound image without displaying the original image, it is difficult to match the magnified ultrasound image with the original ultrasound image.

### BRIEF DESCRIPTION OF THE DRAWINGS

Arrangements and embodiments may be described in detail with reference to the following drawings in which like reference numerals refer to like elements and wherein:

FIG. 1 is a schematic block diagram illustrating an ultrasound image processing system constructed in accordance with one embodiment of the present invention;

FIG. 2 is a flowchart illustrating a method of processing an ultrasound image in accordance with one embodiment of the present invention; and

FIG. 3 is a schematic diagram showing an example of simultaneously displaying an original ultrasound image together with magnified ultrasound images.

### DETAILED DESCRIPTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

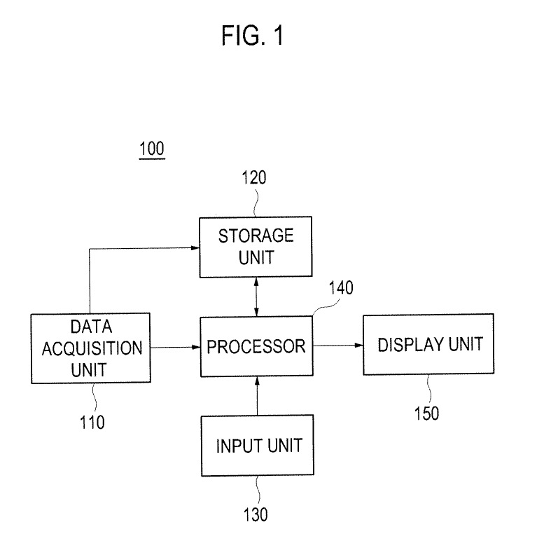

FIG. 1 is a block diagram showing an ultrasound image processing system constructed in accordance with one embodiment of the present invention. As shown in FIG. 1, the ultrasound image processing system 100 includes a data acquisition unit 110, a storage unit 120, an input unit 130, a processor 140 and a display unit 150.

The data acquisition unit 110 transmits ultrasound signal to a target object and receives ultrasound echo signals reflected from the target object. The data acquisition unit 110 forms ultrasound image data based on the ultrasound echo signals. The data acquisition unit 110 includes a probe containing a plurality of transducer elements, a beam former, a digital signal processor and a scan converter. The transducer elements generate ultrasound signals in response to transmit pulse signals. The transducer elements also generate electric signals in response to ultrasound echo signals (hereinafter referred to as “receive signals”). The beam former applies delays to the transmit pulse signals to form an ultrasound transmit beam. Also, the beam former applies delays to the receive signals so as to form receive-focused signals. The digital signal processor processes the receive-focused signal to form ultrasound image data. The scan converter scan-converts the ultrasound image data into a form to allow the ultrasound image data to be displayed on the display unit 150. The storage unit 120 stores the ultrasound image data outputted from the data acquisition unit 110.

The input unit 130 receives region of interest (ROI) setting information for setting a plurality of ROIs on an ultrasound image. The input unit 130 may be a track ball, a mouse, a keyboard, a touch pad or the like.

The processor 140 forms an ultrasound image based on the ultrasound image data received from the data acquisition unit 110. Hereinafter, the ultrasound image is referred to as an original ultrasound image. The processor 140 sets a plurality of ROIs on the original ultrasound image displayed on the display unit based on the ROI setting information inputted through the input unit 130. The processor 140 determines display regions for displaying magnified ultrasound images, which are obtained by magnifying portions of the original ultrasound image within the ROIs (hereinafter referred to as “ROI images”), on a screen of the display unit 150. For example, the processor 140 may determine the magnified ROI images to be displayed on the original ultrasound image. The processor 140 reads out the ultrasound image data corresponding to the ROIs. Then, the processor 140 performs an image magnification process for the read-out ultrasound image data to obtain the magnified ROI images according to preset ratios. The magnified ultrasound images are displayed on the determined display regions of the screen. Further, the processor 140 forms connection lines connecting the ROIs to the magnified ultrasound images one by one on the screen of the display unit 150. Preferably, the connection lines are formed on the original ultrasound image.

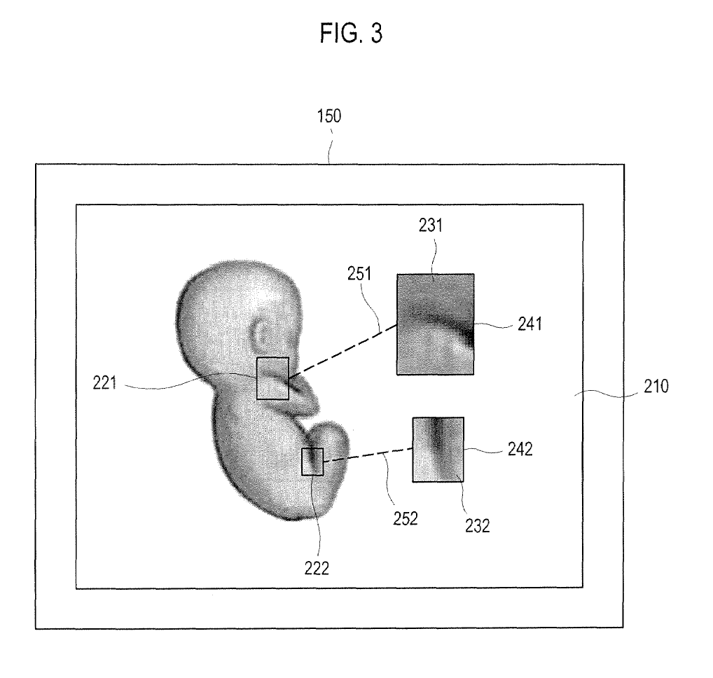

For example, if the ROI setting information for setting two ROIs on the original ultrasound image 210 is inputted through the input unit 130, then the processor 140 sets a first ROI 221 and a second ROI 222 on the original ultrasound image 210 displayed on the screen 152 of the display unit 150 based on the ROI setting information, as shown in FIG. 3. The processor 140 determines a first display region 241 and a second display region 242 for displaying magnified ultrasound images 231 and 232 corresponding to the first and second ROIs 221 and 222 on the screen 152 of the display unit 150. The processor 140 preferably sets the first and second display regions 241 and 242 on the original ultrasound image 210. Further, the processor 140 forms connection lines 251 and 252 connecting the ROIs 221 and 222 to the display regions 241 and 242, respectively. Even if the ROI is set in a rectangular shape and the connection line is set in a dotted line in accordance with one embodiment of the present invention, various shapes can be used to set the ROI and any line capable of showing a connection between the ROI and the corresponding display region can be used in accordance with another embodiment of the present invention.

The processor 140 reads out the ultrasound image data corresponding to the first and second ROIs from the storage unit 120. The processor 140 performs an image magnification process for the read-out ultrasound image data to magnify the ROI images 221 and 222 in a preset ratio, thereby obtaining magnified ultrasound images 231 and 232. The preset ratio for magnifying the ROI image may be set by a user. Even if a view of the target object in the original ultrasound image 210 is moved, the ROIs may be fixed on the original ultrasound image 210. This is so that different magnified ultrasound images may be provided in accordance with one embodiment of the present invention.

The display unit 150 displays the magnified ultrasound images 231 and 232 at the determined display regions 241 and 242, respectively. The magnified ultrasound images 231 and 232 may be 2-dimensional ultrasound images or 3-dimensional ultrasound images.

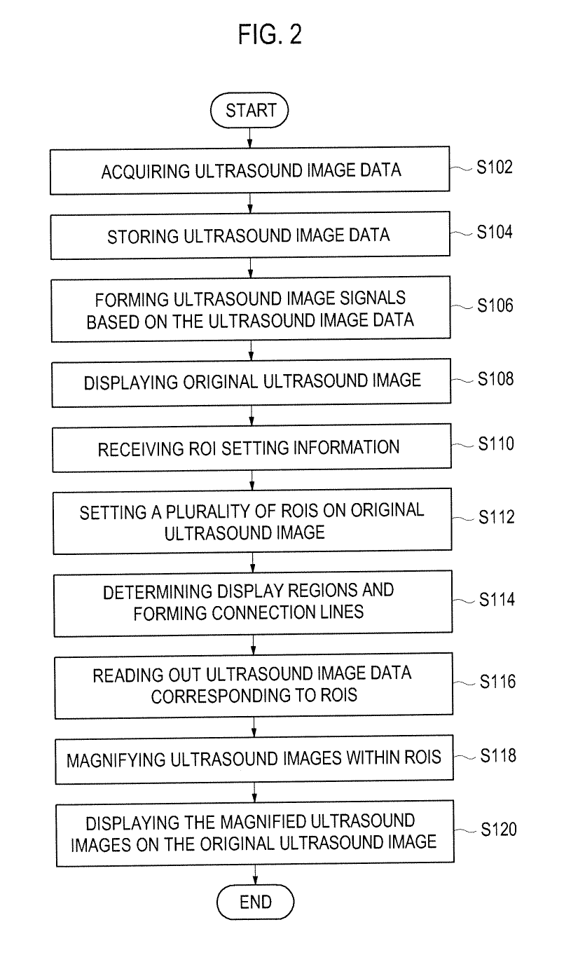

Hereinafter, a method for processing the ultrasound image will be described with reference to FIGS. 2 and 3 in accordance with one embodiment of the present invention.

As illustrated in FIG. 2, the data acquisition unit 110 acquires ultrasound image data at step S102. The storage unit 120 stores the ultrasound image data outputted from the data acquisition unit 110 at step S104. The processor 140 forms ultrasound image signals based on the ultrasound image data at step S106. The display unit 150 displays an ultrasound image (original ultrasound image) based on the ultrasound image signals received from the processor 140 at step S108.

If the ROI setting information is inputted through the input unit 130 from a user at step S110, then the processor 140 sets a plurality of ROIs on the original ultrasound image based on the ROI setting information at step S112. The processor 140 determines display regions for displaying magnified ultrasound images corresponding to the ROIs on the screen 152 of the display unit 150 and forms connection lines connecting the ROIs to the display regions at step S114.

The processor 140 reads out ultrasound image data corresponding to the ROIs from the storage unit 120 at step S116. The processor 140 performs image processing upon the read-out ultrasound image data to magnify the ROI images 221 and 222 in a preset ratio, thereby obtaining magnified ultrasound image signals at step S118. The display unit 150 displays the magnified ultrasound images 231 and 232 based on the image-processed ultrasound image signals at the corresponding display regions of the display unit 150 at step S120.

As mentioned above, since a plurality of ROIs is set on the original ultrasound image, a plurality of magnified ultrasound images can be provided at the same time. Also, since the connection lines connecting the ROIs with the magnified ultrasound images are provided, it becomes easy to identify which magnified ultrasound image corresponds to the ROI.

In accordance with one embodiment of the present invention, an image processing system comprises: an image data acquisition unit for acquiring image data from a target object; a processor for forming an original image based on the image data; and an input unit for receiving region of interest (ROI) setting information for setting a plurality of ROIs on the original image, wherein the processor is further operable to magnify a plurality of images within the ROIs in a preset ratio and display the plurality of magnified images together with the original image such that the magnified images are displayed on the original image.

In accordance with another embodiment of the present invention, an image processing method comprises: a) acquiring image data from a target object; b) displaying an original image based on the image data; c) receiving region of interest (ROI) setting information for setting a plurality of ROIs on the original image from a user; d) magnifying a plurality of images within the ROIs in a preset ratio; and e) displaying a plurality of magnified images together with the original image such that the magnified images are displayed on the original image.

Any reference in this specification to “one embodiment,” “an embodiment,” “example embodiment,” etc., means that a particular feature, structure or characteristic described in connection with the embodiment is included in at least one embodiment of the invention. The appearances of such phrases in various places in the specification are not necessarily all referring to the same embodiment. Further, when a particular feature, structure or characteristic is described in connection with any embodiment, it is submitted that it is within the purview of one skilled in the art to effect such feature, structure or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image processing system, comprising:
an image data acquisition unit for acquiring image data from a target object;
a processor for forming an original image based on the image data; and
an input unit for receiving region of interest (ROT) setting information for setting a plurality of ROIs on the original image,
wherein the processor is further configured to magnify a plurality of images within the ROIs in a preset ratio and display the plurality of magnified images together with the original image such that the magnified images are displayed on the original image.

2. The image processing system of claim 1, wherein the processor forms a plurality of connection lines for connecting the ROIs to the corresponding magnified images.

3. The image processing system of claim 2, wherein the processor determines a plurality of display regions on the original image for displaying the magnified images.

4. The image processing system of claim 1, wherein the image data include ultrasound image data.

5. The image processing system of claim 1, further comprising a storage unit for storing the image data.

6. An image processing method, comprising:
a) acquiring image data from a target object;
b) displaying an original image based on the image data;
c) receiving region of interest (ROI) setting information for setting a plurality of ROIs on the original image from a user;
d) magnifying a plurality of images within the ROIs in a preset ratio; and
e) displaying a plurality of magnified images together with the original image such that the magnified images are displayed on the original image.

7. The image processing method of claim 6, wherein the step d) includes:
d1) determining a plurality of display regions on the original image for displaying the magnified images; and
d2) forming a plurality of connection lines for connecting the display regions to the ROIs, respectively.

8. The image processing method of claim 7, wherein the step e) includes displaying the connection lines on the original image.

9. The image processing method of claim 7, wherein the image data includes ultrasound image data.

10. The image processing method of claim 7, wherein the step a) includes storing the image data.
